(19) United States
(12) Patent Application Publication
(10) Pub. No.: US 2025/0124507 A1
(43) Pub. Date: Apr. 17, 2025

(54) SYSTEMS AND METHODS FOR ENHANCED SECURITIES LENDING

(71) Applicant: Wells Fargo Bank, N.A., San Francisco, CA (US)

(72) Inventors: Raghuram Addepalli, Jersey City, NJ (US); Sai Bandhakavi, Jersey City, NJ (US); Vanio Markov, Ridgewood, NJ (US); Abhijit Rao, Irvine, CA (US)

(21) Appl. No.: 17/651,261

(22) Filed: Feb. 16, 2022

Related U.S. Application Data
(60) Provisional application No. 63/149,978, filed on Feb. 16, 2021.

(51) Int. Cl. G06Q 40/04; G06N 10/20; G06N 10/60

(52) U.S. Cl. CPC G06Q 40/04; G06N 10/20; G06N 10/60

(57) ABSTRACT

A method for enhanced securities lending, the method comprising: receiving a request from a user for a first number of stocks in a particular security; transmitting a quote for a second number of stocks in the security available for lending to the user, wherein the second number of stocks is less than or equal to the first number of stocks; predicting, at least in part using a quantum annealer or a quantum computer and based on a history of engagement of the user, a third number of stocks in the particular security to be reserved, the third number of stocks being less than or equal to the second number of stocks; reserving the third number of stocks for execution by the user; and decrementing a total number of stocks in the particular security by the third number of stocks.

### CROSS-REFERENCE TO RELATED APPLICATIONS

This application claims the benefit of U.S. Provisional Patent Application No. 63/149,978, filed Feb. 16, 2021, the entire contents of which are incorporated herein by reference.

### TECHNOLOGICAL FIELD

Example embodiments of the present disclosure relate generally to enhanced securities lending and, more particularly, to systems and methods for enhanced securities lending through the use of quantum computers.

### BACKGROUND

With securities lending, funds (e.g., mutual funds) lend their stocks or bonds to generate increasing returns. When a client wants to buy a stock or short a stock, the client puts in an order. The lender may then allocate a corresponding number of stocks in a transaction to be executed. The allocated number of stocks may or may not then exchange hands, but nevertheless that number of stocks are decremented from a total held by the lender. These decremented securities are not available for others to purchase, at least until the buyer executes or cancels the transaction. If the buyer cancels, this prevents other opportunities to sell such securities for a period of time. Further, these transactions must be evaluated quickly and, typically, over 70,000 transactions of this nature occur in a day.

### BRIEF SUMMARY

Accordingly, Applicant has recognized a need for systems and methods to quickly and accurately predict the number of stocks to reserve for a particular buyer. Such systems and methods may utilize a classifier to predict the number of stocks the buyer may execute or purchase. The classifier may be an output of a blended or stacked model. The blended or stacked model may utilize machine learning based on classical computing and quantum computing, e.g., via quantum circuitry.

Systems, apparatuses, methods, and computer program products are disclosed herein for enhanced securities lending. Such systems and methods may ensure an accurate representation of the number of stocks a buyer is likely to execute. Further, the predicted or likely number of stocks to execute may be quickly determined based on the use of a blend of classic computing and quantum computing.

In one example embodiment, a method is provided for enhanced securities lending. The method includes receiving, by an input-output circuitry, a request from a user for a first number of stocks in a particular security. The method includes determining, by a client locate circuitry, a quote for a second number of stocks in the security available for lending to the user, wherein the second number of stocks is less than or equal to the first number of stocks. The method includes predicting, by a reserved stock classifier circuitry and based on (1) a history of engagement of the user, (2) the first number of stocks, and (3) the second number of stocks, a third number of stocks in the particular security to be reserved, the third number of stocks being less than or equal to the second number of stocks. Predicting the third number of stocks may utilize a quantum reinforcement learning technique, a quantum annealer, or quantum computer of the reserved stock classifier and/or a classical computer of the reserved stock classifier circuitry. The method includes reserving, by the reserved stock classifier circuitry, the third number of stocks for execution by the user. Finally, the method includes decrementing, by the reserved stock classifier circuitry, a total number of stocks in the particular security by the third number of stocks. In another example embodiment, the predicting of the third number of stocks utilizes a quantum reinforcement learning technique. In an embodiment, the method may include generating and/or storing logs of explaining how the second number and/or third number were obtained. Such logs may be requirements of one or more of current United States regulations or other country regulations. In an embodiment, the method may include receiving, by the reserved stock classifier circuitry, a fourth number of stocks actually executed by the user. In such an embodiment, the first number of stocks, the second number of stocks, the third number of stocks, and the fourth number of stocks may be utilized to re-train the reserved stock classifier or other model of the reserved stock classifier circuitry.

In another example embodiment, an apparatus is provided for enhanced security lending. The apparatus may comprise an input-output circuitry configured to receive a request from a user for a first number of stocks in a particular security. The apparatus may comprise client locate circuitry configured to determine a quote for a second number of stocks in the security, wherein the second number of stocks is less than or equal to the first number of stocks and transmit a quote for a second number of stocks in the security available for lending to the user. The apparatus may comprise a reserved stock classifier circuitry configured to: (a) predict, based on (1) a history of engagement of the user, (2) the first number of stocks, and (3) the second number of stocks, a third number of stocks in the security to be reserved, the third number of stocks being less than or equal to the second number of stocks; (b) reserve the third number of stocks for execution by the user; and (c) decrement a total number of stocks in the security by the third number of stocks.

In one example embodiment, a computer program product is provided for enhanced security lending. The computer program product may comprise at least one non-transitory computer-readable storage medium storing software instructions that, when executed, cause an apparatus to perform actions. The software instructions, when executed, may receive a request from a user for a first number of stocks in a particular security. The software instructions, when executed, may determine a quote for a second number of stocks in the security, wherein the second number of stocks is less than or equal to the first number of stocks. The software instructions, when executed, may transmit a quote for a second number of stocks in the security available for lending to the user. The software instructions, when executed, may predict, based on (1) a history of engagement of the user, (2) the first number of stocks, and (3) the second number of stocks, a third number of stocks in the security to be reserved, the third number of stocks being less than or equal to the second number of stocks. The software instructions, when executed, may reserve the third number of stocks for execution by the user. The software instructions, when executed, may decrement a total number of stocks in the security by the third number of stocks.

The foregoing brief summary is provided merely for purposes of summarizing example embodiments illustrating some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments of the present disclosure in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a device that may perform various operations in accordance with some example embodiments described herein.

FIG. 3 illustrates an example schematic block diagram used in some example embodiments described herein.

FIG. 4 illustrates another example schematic block diagram used in some example embodiments described herein.

FIG. 5 illustrates another example schematic block diagram used in some example embodiments described herein.

FIG. 6 illustrates yet another example schematic block diagram used in some example embodiments described herein.

FIG. 7 illustrates an example flowchart for predicting a number of stocks to reserve, in accordance with some example embodiments described herein.

### DETAILED DESCRIPTION

Some embodiments of the present disclosure will now be described more fully hereinafter with reference to the accompanying figures, in which some, but not all, embodiments of the disclosures are shown. Indeed, these disclosures may be embodied in many different forms and should not be construed as limited to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

As used herein, a “non-transitory machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. The memory may store or include instructions executable by the processor.

As used herein, a “processor” or “processing circuitry” may include, for example one processor or multiple processors included in a single device or distributed across multiple computing devices. The processor 202 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

The terms “classical computing”, “classical computer”, “classical computing device”, and “classical computing system” are used to refer to a binary computing device or device. A classical computer may execute functions or operations in a deterministic and logical way.

The terms “quantum computing”, “quantum computer”, “quantum computing device”, “quantum computing system”, and “quantum annealer” are used to refer to a computing device or device utilizing quantum bits (which may also be referred to as qubits).

The terms “quantum bit” and “qubit” both refer to a basic unit of quantum information comprising a two-state, or two-level, quantum mechanical system, such as: the polarization of a single photon (e.g., a photon encoded using a quantum basis as previously defined); the spin of a single electron (e.g., a spin qubit comprising the spin up state |1> and the spin down state |0>); the energy level of a single atom (e.g., a superconducting qubit); or any other suitable qubit. A quantum bit may exhibit quantum superposition of multiple states, unlike a classical bit, which is either a 0 or a 1. The superposition of a qubit's states is a feature of quantum mechanics, and enables certain calculations to be performed probabilistically in parallel and at a faster rate by a quantum computer than is possible by a classical computer.

### Overview

As noted above, methods, apparatuses, systems, and computer program products are described herein that provide for enhanced securities lending. Traditionally, it has been very difficult to accurately determine the number of stocks a buyer attempting to locate a stock may actually execute on. Such issues are even more difficulty due to the frequency of such transactions occurring during a day (e.g., thousands). In addition, historically there has been no way to provide an accurate prediction of these values in the short span of time between a sent offer to a buyer and the time to report or evaluate the unexecuted assets (e.g., seconds or minutes). Finally, overestimating the number of stock results in unrealized gains, as each stock not ultimately transacted remains with the lender, despite other potential opportunities.

In contrast to these conventional techniques for lending securities, the present disclosure describes an enhanced system and method to lend securities. Such systems and methods may include a reserved stock classifier. The reserved stock classifier may include a memory and processing circuitry. The memory may include instructions executable by the processing circuitry. The instructions, when executed, may, produce a classifier. The classifier may be produced using a hybrid approach. The hybrid approach may include the use of models utilizing a combination of traditional or classical computers and quantum computers. Data, such as a history of engagement between the client and the lender, may be passed to the classical computer, may be modeled utilizing a reinforcement, supervised, or unsupervised machine learning algorithm, such as a neural network, support vector machine, linear regression, decision trees, Naive Bayes, Nearest Neighbor, and/or some combination therein. While training via the machine learning algorithm on the traditional or classical computer is occurring, the same data may be sent to a quantum computer. The quantum computer may train a model to produce a classifier, but may do so significantly faster and more efficiently, e.g., utilizing similar algorithms noted above (e.g., Bayesian networks, recurrent neural network, extreme gradient boosted trees, an average blender of the aforementioned approaches, and/or some combination thereof) in addition to reinforcement learning (e.g., quantum reinforcement learning (QRL) or reinforcement learning that relies on quantum models of computation, providing computational advantages). Data used to train the models may include the prior client purchase or history data and/or current predictions and/or an actual amount of stocks executed by a user for a current transaction or prediction. In another embodiment, in addition to or separate from the machine learning model, the quantum computer and/or classical computer may generate a statistical model to be utilized in the operations described below

Once a classifier, and/or in some examples a statistical model, is produced, then another computing device may utilize the classifier to determine or predict a number of stocks to reserve based on a client locate request. The another computing device may include processing circuitry and memory. The instructions, when executed, may, in response to reception of a client locate request, determine and transmit a quote. The client locate request may include a first number of stocks. The quote may include a second number of stocks. The second number of stocks may be less than or equal to the first number. Once the quote is sent, the another computing device may determine or predict a third number of stocks to reserve. The third number of stocks may be less than or equal to the second number of stocks. The third number may be used as the reserved number of stocks. In other words, the total stocks held by the lender may be decremented by the third number of stocks, until either the client executes the transaction or cancels the order. To predict or determine the third number of stocks, the another computing device may utilize the classifier noted above with a client's history of engagement as an input. In another embodiment, the computing device may use a statistical model, in addition to or separate from the classifier, to predict the third number of stocks to reserve.

Accordingly, the present disclosure sets forth systems, methods, and apparatuses that allow for accurate and quick determinations of how many stocks to actually allocate or reserve in relation to a total number of stock based on history of engagement with the client and other factors. There are many advantages of these and other embodiments described herein. For instance, the lender may limit the number of potentially executed stocks decremented from the total held by the lender. In this way, the utilization of stocks is maximized, with fewer stocks being held in a pending state between execution and quote. Further, for instance, such a determination may be made quickly, based on the use of quantum computing, in combination with or separate from classical computing.

Although a high level explanation of the operations of example embodiments has been provided above, specific details regarding the configuration of such example embodiments are provided below.

### System Architecture

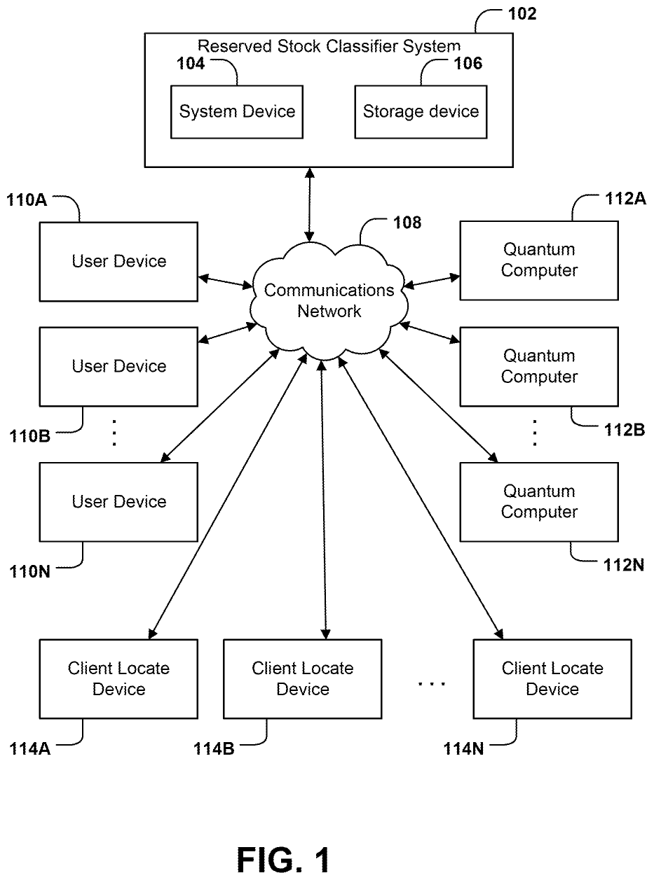

Example embodiments described herein may be implemented using any of a variety of computing devices or servers. To this end, FIG. 1 illustrates an example environment within which embodiments of the present disclosure may operate. As illustrated, a reserved stock classifier system 102 may include a system device 104 in communication with a storage device 106. Although system device 104 and storage device 106 are described in singular form, some embodiments may utilize more than one system device 104 and/or more than one storage device 106. Additionally, some embodiments of the reserved stock classifier system 102 may not require a storage device 106 at all. Whatever the implementation, the reserved stock classifier system 102, and its constituent system device(s) 104 and/or storage device(s) 106 may receive and/or transmit information via communications network 108 (e.g., the Internet) with any number of other devices, such as one or more of user device 110A, user device 110B, through user device 110N, quantum computer 112A, quantum computer 112B, through quantum computer 112N, client locate device 114A, client locate device 114B, and/or through client locate 114N.

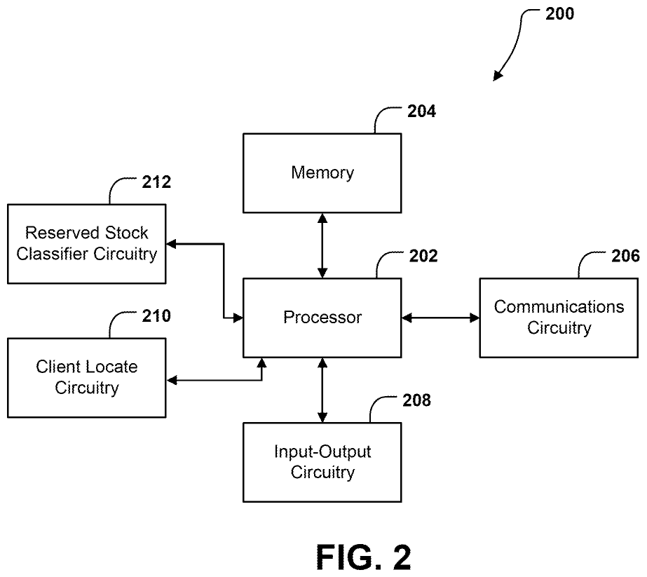

System device 104 may be implemented as one or more servers, which may or may not be physically proximate to other components of reserved stock classifier system 102. Furthermore, some components of system device 104 may be physically proximate to the other components of reserved stock classifier system 102 while other components are not. System device 104 may receive, process, generate, and transmit data, signals, and electronic information to facilitate the operations of the reserved stock classifier system 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the reserved stock classifier system 102. Storage device 106 may store information relied upon during operation of the reserved stock classifier system 102, such as request stocks, predicted offers, predicted reservations, United States (US) regulations and/or information or data related to reporting formats related to such current US regulations, other country regulations, an internal audit or governance, and/or client history data, that may be used by the reserved stock classifier system 102, data and documents to be analyzed using the reserved stock classifier system 102, or the like. In addition, storage device 106 may store control signals, device characteristics, and access credentials enabling interaction between the reserved stock classifier system 102 and one or more of the user devices 110A-110N, quantum computers 112A-112N, or client locate devices 114A-114N.

The one or more client locate devices 114A-114N may be embodied by any storage devices known in the art. Similarly, the one or more user devices 110A-110N and/or the one or more client locate devices 114A-114N may be embodied by any computing devices known in the art, such as desktop or laptop computers, tablet devices, smartphones, or the like. Finally, the one or more quantum computers 112A-112N may be embodied by any quantum computing device known in the art. One or more of the one or more quantum computers 112A-112N may be embodied by a quantum annealer. The one or more user devices 110A-110N, the one or more quantum computers 112A-112N, and the one or more client locate devices 114A-114N need not themselves be independent devices, but may be peripheral devices communicatively coupled to other computing devices.

Although FIG. 1 illustrates an environment and implementation of the present disclosure in which the reserved stock classifier system 102 interacts with one or more of user devices 110A-110N, quantum computers 112A-112N, or client locate devices 114A-114N. In some embodiments one or more of the users or agents may directly interact with the reserved stock classifier system 102 (e.g., via input/output circuitry of system device 104), in which case a separate device may not need to be utilized for such users or agents. Whether by way of direct interaction or interaction via a separate device, users and agents may communicate with, operate, control, modify, or otherwise interact with the reserved stock classifier system 102 to perform functions described herein and/or achieve benefits as set forth in connection with this disclosure.

### Example Implementing Apparatuses

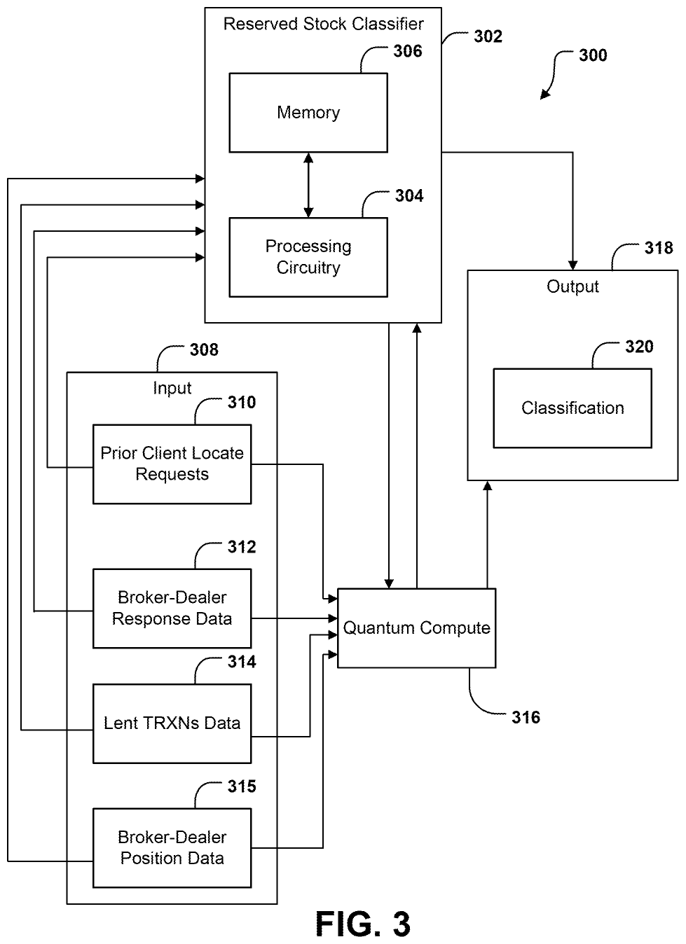

System device 104 of the reserved stock classifier system 102 (described previously with reference to FIG. 1) may be embodied by one or more computing devices or servers, shown as apparatus 200 in FIG. 2. As illustrated in FIG. 2, the apparatus 200 may include processor 202, memory 204, communications circuitry 206, input-output circuitry 208, client locate circuitry 210, and reserved stock classifier circuitry 212, each of which will be described in greater detail below. While the various components are only illustrated in FIG. 2 as being connected with processor 202, it will be understood that the apparatus 200 may further comprise a bus (not expressly shown in FIG. 2) for passing information amongst any combination of the various components of the apparatus 200. The apparatus 200 may be configured to execute various operations described herein, such as those described above in connection with FIG. 1 and below in connection with FIGS. 3-7.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor 202 may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Furthermore, the communications circuitry 206 may include the processing circuitry for causing transmission of such signals to a network or for handling receipt of signals received from a network.

The apparatus 200 may include input-output circuitry 208 configured to provide output to a user and, in some embodiments, to receive an indication of user input. It will be noted that some embodiments will not include input-output circuitry 208, in which case user input (e.g., securities or stock requests) may be received via a separate device such as user devices 110A-110N, quantum computers 112A-112N, and/or client locate devices 114A-114N. The input-output circuitry 208 may comprise a user interface, such as a display, and may further comprise the components that govern use of the user interface, such as a web browser, mobile application, dedicated client device, or the like. In some embodiments, the input-output circuitry 208 may include a keyboard, a mouse, a touch screen, touch areas, soft keys, a microphone, a speaker, an image capture device, and/or other input/output mechanisms. The input-output circuitry 208 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises client locate circuitry 210 that, in response to a request from a client (e.g., directly or indirectly) or other source, determines and/or predicts an offer to a client. The client locate circuitry 210 may utilize processor 202, memory 204, or any other hardware component included in the apparatus 200 to perform these operations, as described in connection with FIGS. 3-7 below. The client locate circuitry 210 may further utilize communications circuitry 206 to gather data from a variety of sources (e.g., user devices 110A-110N, as shown in FIG. 1, or other devices), may utilize input-output circuitry 208 to receive data from a user, and in some embodiments may utilize processor 202 and/or memory 204 to receive a client request and/or perform the determinations and/or predictions regarding such a client request. The output of the client locate circuitry 210 may be transmitted to other circuitry of the apparatus 200 (e.g., communications circuitry 206, input-output circuitry 208, and/or reserved stock classifier circuitry 212). In an embodiment, the client locate circuitry 210, may receive the client request, a client history or data related to the client history, and/or other data related client transactions. The client locate circuitry 210 may include a model (e.g., a quantum computer and/or classical computer based model). The model may receive as inputs, the data related to client history and/or transactions. The model may output a number of stock or securities to offer the customer based on such data. Such a number of stock or securities may be less than or equal to the number requested by the client. Further, the client locate circuitry 210 may perform other functions, such as determining whether a particular stock or security requested by a client is available and/or reporting or logging functionality configured to document and/or explain how the number of stock or securities to offer the customer was determined or predicted. Such reports or logs may be based on and/or formatted based on current US regulations, other country regulations, or an internal audit or governance. Further, keeping of such logs or reports may be required by the current US regulations or regulations related to other countries. In another example, generating such logs or reports may be performed, in addition to or separate from the client locate circuitry 210, by other circuitry, such as reserved stock classifier circuitry 212.

In addition, the apparatus 200 further comprises a reserved stock classifier circuitry 212 that may predict a number of stock to reserve for a particular client. The reserved stock classifier circuitry 212 may utilize processor 202, memory 204, or any other hardware component included in the apparatus 200 to perform these operations, as described in connection with FIGS. 3 through 7 below. The reserved stock classifier circuitry 212 may further utilize communications circuitry 206 to gather data from a variety of sources (e.g., user devices 110A-110N, quantum computers 112A-112N, or client locate devices 114A-114N, or storage device 106, as shown in FIG. 1), may utilize input-output circuitry 208 to receive data from a user or other source, and in some embodiments may utilize processor 202 and/or memory 204 to predict a number of stock or securities to reserve. The reserved stock classifier circuitry 212 may include a model (e.g., a quantum computer and/or classical computer based model trained with prior client purchase or history data and/or current predictions and/or an actual amount of stocks executed by a user). The model may receive, as input, the number of stock or securities offered to a client, the client's previous purchase history, specific details related to a client (e.g., purchase habits in regards to specific stock or securities), the number of stock or securities available, the number of stock or securities currently reserved, and/or other data related to the client and/or the stock or security requested. In another embodiment, the model may be received, by the reserved stock classifier circuitry 212, from a quantum computer and/or a classical computer. Further, the reserved stock classifier circuitry 212 may perform other functions, such as reporting or logging functionality configured to document and/or explain how the number of stock or securities to reserve was determined or predicted. Such reports or logs may be based on and/or formatted based on current US regulations, other country regulations, or an internal audit or governance. Further, keeping of such logs or reports may be required by the current US regulations or regulations related to other countries. In another example, generating such logs or reports may be performed, in addition to or separate from the reserved stock classifier circuitry 212, by other circuitry, such as client locate circuitry 210.

In another embodiment, the client locate circuitry 210 and/or the reserved stock classifier circuitry 212 may, in response to an actual amount borrowed or executed by the client, update the logs or reports with the actual amount borrowed or executed. Such updates may be required by the current US regulations or regulations related to other countries. Further, the model of the client locate circuitry 210 and/or the reserved stock classifier circuitry 212 may be refined, re-trained, and/or updated based on the actual amount borrowed or executed by the client.

Although components 202-212 are described in part using functional language, it will be understood that the particular implementations necessarily include the use of particular hardware. It should also be understood that certain of these components 202-212 may include similar or common hardware. For example, the client locate circuitry 210 and reserved stock classifier circuitry 212 may each at times leverage use of the processor 202, memory 204, communications circuitry 206, or input-output circuitry 208, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the client locate circuitry 210 and reserved stock classifier circuitry 212 may leverage processor 202, memory 204, communications circuitry 206, or input-output circuitry 208 as described above, it will be understood that any of these elements of apparatus 200 may include one or more dedicated processors, specially configured field programmable gate arrays (FPGA), or application specific interface circuits (ASIC) to perform its corresponding functions, and may accordingly leverage processor 202 executing software stored in a memory (e.g., memory 204), or memory 204, communications circuitry 206 or input-output circuitry 208 for enabling any functions not performed by special-purpose hardware elements. In all embodiments, however, it will be understood that the client locate circuitry 210 and reserved stock classifier circuitry 212 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments of the present disclosure are described below in connection with a series of graphical user interfaces and flowcharts.

### Example Operations

Turning first to FIG. 3. a reserved stock system 300 is shown that represents an example stock or security reservation prediction flow, as, for example, implemented in reserved stock classifier system 102 and/or apparatus 200. To perform the operations described below, the apparatus 200 may utilize one or more of processor 202, memory 204, communications circuitry 206, input-output circuitry 208, client locate circuitry 210, reserved stock classifier circuitry 212, and/or any combination thereof. It will be understood that user interaction with the reserved stock classifier system 102 may occur directly via input-output circuitry 208, or may instead be facilitated by a separate user device 110A-110N, as shown in FIG. 1, and which may have similar or equivalent physical componentry facilitating such user interaction.

As illustrated, a reserved stock system 300 may include the reserved stock classifier 302. The reserved stock classifier 302 may include a memory 306 and processing circuitry 304, the memory 306 in communication with the processing circuitry 304. The memory 306 may include data and instructions executable by the processing circuitry 304. The reserved stock classifier system 102 may be in communication with quantum compute 316. Quantum compute 316 may include various components to output or determine a classifier, prediction, or indicator, as will be described herein. Quantum compute 316 may include a quantum computer, quantum circuitry, quantum simulator, and/or other quantum based computer. Although reserved stock classifier 302 and quantum compute 316 are described in singular form, some embodiments may utilize more than one computing device for the reserved stock classifier 302 and/or the quantum compute 316. Whatever the implementation, the reserved stock classifier 302 and the quantum compute 316 may receive and/or transmit information via communications network (e.g., the Internet, an intranet, or via hardwire) with any number of other devices, such as the input 308 and the output 318.

The reserved stock classifier 302 may be implemented as one or more servers, which may or may not be physically proximate to other components of the reserved stock system 300. Furthermore, some components of the reserved stock classifier 302 may be physically proximate to the other components of reserved stock system 300 while other components are not. Reserved stock classifier 302 may receive, process, generate, and transmit data, signals, and electronic information to facilitate the operations of the reserved stock system 300.

The input 308 and output 318 may comprise data stored on one or more computing device or storage device. The one or more computing device or storage device may comprise a distinct component from the reserved stock classifier 302, or may comprise an element of reserved stock classifier 302 (e.g., memory 306 or other storage devices). Storage devices may store information relied upon during operation of the reserved stock classifier 302, such as inputs 308 that may be used by the reserved stock classifier 302, data and documents to be analyzed using the reserved stock classifier 302, or the like.

The data stored in relation to the input 308 and output 318 may be transmitted to various locations or users. The input 308 may be transmitted to the quantum compute 316 and/or the reserved stock classifier 302. The reserved stock classifier 302 may, after determining a classification 320 or indication, transfer such data as an element of output 318. The data included with the input may include prior client locate requests 310. The prior client locate requests 310 may include various data points, such as the number of transactions initiated by the client, the number of transactions executed by the client, and/or the number of transactions canceled by the client. Various other data points related to client history and/or previous transactions may be utilized in such processes. For example, other data that may be transferred to the reserved stock classifier, is broker-dealer response data 312. Such data may indicate how many orders a lender has purchased. Further, such data may be used to determine the total number of stock currently owned for a particular security. Other data may include lent TRXNs Data 314. Such transaction data may be the total number of and type of stock a buyer holds or has bought. Finally, broker-dealer position data 315 may be sent and may include the number of stocks purchased by a broker by the lender and/or the number and type of stocks held by the lender in relation to the broker.

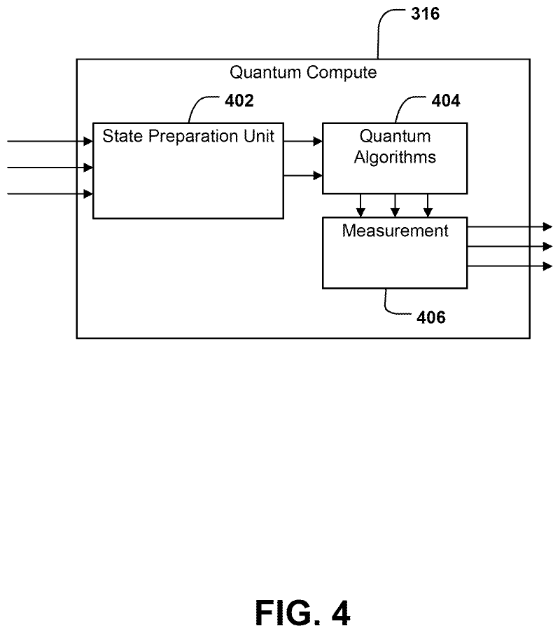

Turning next to FIG. 4, the quantum compute 316 (e.g., as illustrated in FIGS. 3 and 4) may include a state preparation unit 402. The state preparation unit 402 may pre-process data. The quantum compute 316 may include different quantum algorithms 404, such as e.g., Bayesian networks, recurrent neural networks, extreme gradient boosted trees, an average blender of the aforementioned approaches, and/or some combination thereof, as describe herein. Utilizing quantum logic gates or other quantum computing methods, quantum compute 316 may train, e.g., using a measurement block 406, a machine learning model (e.g., a classifier) to predict a number of stocks to reserve based on a buyer's history of engagement (e.g., previous predictions and an actual number of stocks executed by a user and/or other data or information related to the user).

Once a classifier is generated, a computing device (e.g., reserved stock classifier system 102 as illustrated in FIG. 1), including a system device and memory, may utilize the classifier to determine, predict, or indicate a number of stocks, based on client locate requests, to reserve for a particular transaction. The computing device may retrieve data, e.g., client locate requests, via a communications network. Further, the reserved stock classifier, e.g., 302 in FIG. 3, may communicate with the computing device over the communications network. The computing device may send data for determination, prediction, or indication of a number of stock by the reserved stock classifier 302. The computing device may obtain or receive instructions or an application from the reserved stock classifier 302 for determining, predicting, or indicating the number of stock or securities to be reserved based on a client interaction.

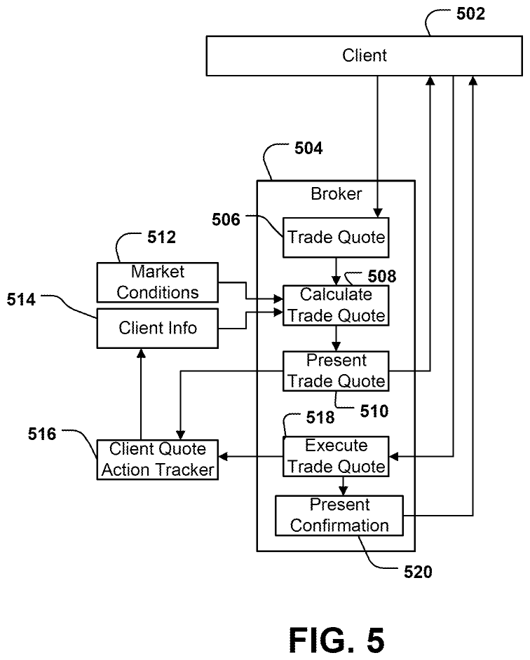

FIG. 5 represents an illustration of a device to utilize the reserved stock classifier. In such an embodiment, the client 502 may request a locate from the broker device 504. The client 502 may request a locate from other brokers as well. The broker device 504, upon reception of the request for a locate, may generate a trade quote. The trade quote may include a number of stocks that is either less than or equal to the number in the client locate. The broker device 504 may initiate the trade quote 506 process. The broker device 504 may calculate the trade quote 508, and may then present the trade quote 510. For example, the trade quote 510 may be presented/displayed, via a user interface, to a client 502. The method to calculate the trade quote 508 may include considering market conditions 512 and client info 514, e.g., a history of engagement between the client 502 and the broker device 504 (e.g., previous predictions and an actual number of stocks executed by a user and/or other data or information related to the user). The reserved stock classification or classifier may utilize such data to determine a number of stock to actually reserve, which may be less than the number quoted to the client 502. Once a number of stocks to reserve is determined, the broker device 504 may present the trade quote 518. A client quote action tracker 516 may decrement a total number of a particular stock by the number of stocks to be reserved. If the client 502 decides to execute the trade quote 518, then the broker device 504 may change the deduction of the reserved number of stock from temporary to permanent. The broker device 504 may also send a confirmation 520 to the client 502, to confirm the transaction. Other factors that may be considered when determining a number of stocks to decrement is a stock utilization, e.g., the inventory and market for a security, and the initial hard-to-borrow score. The broker device 504 may further lower lending fees, based on likelihood to execute on a number of stocks. The broker device 504 described above may be any type of computing device or server.

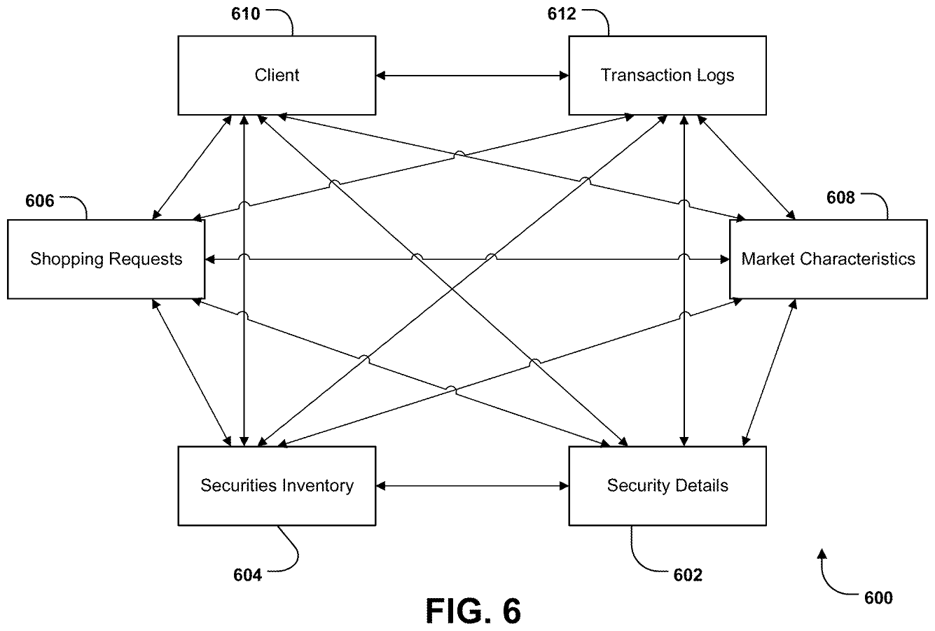

FIG. 6 illustrates system 600, which comprises a use case and various data sources for a reserved stock classifier. The client 610 may provide a history of engagement (e.g., previous predictions and an actual number of stocks executed by a user and/or other data or information related to the user), an order for a particular stock, a locate request, and/or acceptance of offer. Transaction logs 612 regarding the overall transactions made in regards to the lender may be provided to the reserved stock classifier. Further, market characteristics 608 may be provided, such as how much of a particular stock does the lender have, is the stock hard to buy, and/or if the stock is hard to buy, what is the stocks hard to buy score. The reserved stock classifier may also collect securities details 602 and securities inventory 604. Finally, the reserved stock classifier may also receive shopping requests 606. The shopping requests 606 may include data related to a potential order that is being sent to other lenders or brokers.

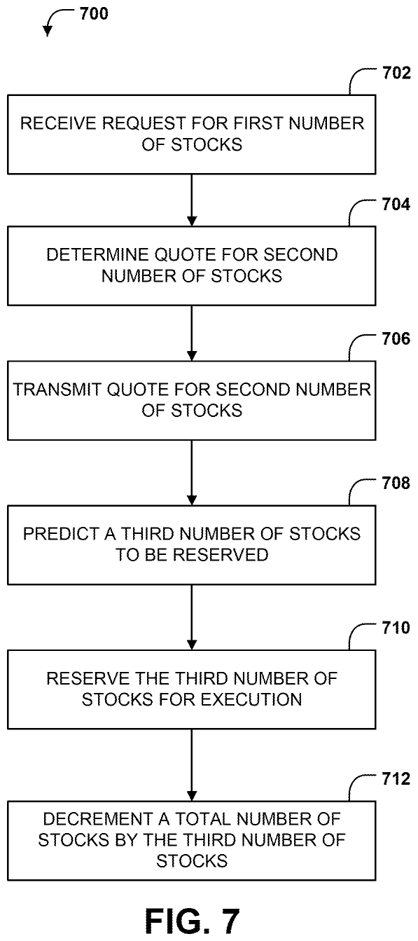

Turning to FIG. 7, an example flowchart 700 is illustrated that contains example operations implemented by example embodiments described herein. The operations illustrated in FIG. 7 may, for example, be performed by system device 104 of the reserved stock classifier system 102 shown in FIG. 1, which may in turn be embodied by an apparatus 200, which is shown and described in connection with FIG. 2. To perform the operations described below, the apparatus 200 may utilize one or more of processor 202, memory 204, communications circuitry 206, input-output circuitry 208, client locate circuitry 210, reserved stock classifier circuitry 212, and/or any combination thereof. It will be understood that user interaction with the reserved stock classifier system 102 may occur directly via input-output circuitry 208, or may instead be facilitated by a separate user device 110A-110N, as shown in FIG. 1, and which may have similar or equivalent physical componentry facilitating such user interaction.

As shown by operation 702, the apparatus 200 include means, such as communications circuitry 206 and/or input-output circuitry 208, for receiving, from a client, a locate request or a request for a first number of stock or securities. The request may include a bid or buy at particular price. The locate request may include fees typically included in such a transaction. However, based on the history of engagement (e.g., previous predictions and an actual number of stocks executed by a user and/or other data or information related to the user) and other factors, e.g., the prediction, indication, or determination, the apparatus 200 may adjust or lower the fees.

As shown by operation 704, the apparatus 200 include means, such as client locate circuitry 210, for determining a quote for a second number of stocks. The second number of stocks may be less than or equal to the first number of stocks. The second number of stocks may be determined by the apparatus 200. Such a determination may be based on market conditions, the number of stocks in the request, the number of stocks owned by the lender, any other currently pending quotes (e.g., quotes which have not been executed), client history, client transaction history, client purchase history, client funds available, and/or other data points related to the client and/or stock or security requested. In an embodiment, the second number may be recorded in a log or report, according to one or more of current US regulations, other country regulations, or an internal audit or governance. Further, how the second number was determined (e.g., the reasons why the second number was determined) may be recorded in the log or report.

As shown by operation 706, the apparatus 200 include means, such as client locate circuitry 210, for transmitting the quote for the second number of stocks to the client. The quote may be transmitted to the client's device or a user interface accessible by the client.

As shown by operation 708, the apparatus 200 include means, such as reserved stock classifier circuitry 212, for predicting a third number of stocks to be reserved. Such a third number may be predicted by a model generated by a quantum computer and/or classical computer. The prediction may be a number generated via the reserved stock classifier circuitry 212, the number indicating a number of stock or securities to reserve. The reserved stock classifier circuitry 212 may obtain or receive code related to model (e.g., such as, receiving a trained model) for execution, the code or model to determine, predict, or indicate the third stock of stocks or, in other words, the number of stock a client is most likely to buy. In an embodiment, the third number may be recorded in a log or report, according to current US regulations, other country regulations, or an internal audit or governance. Further, how the third number was determined (e.g., the reasons why the third number was determined) may be recorded in the log or report.

As shown by operation 710, t the apparatus 200 include means, such as reserved stock classifier circuitry 212, for reserving the third number of stocks for execution. The reservation may include removing the stocks from an available pool of stock. In other words, the lender may have a number of a particular type of stock. Since the apparatus 200 is agreeing to sell some of the particular asset, even though those stocks have not been allocated, transferred, or assigned, the third number of stocks may be counted against or used to decrement the total.

Finally, as shown by operation 712, the apparatus 200 include means, such as reserved stock classifier circuitry 212, for decrementing the total number of stocks by the third number of stocks. The third number of stocks may remain reserved until either the client executes the stocks or cancels the request. Upon execution by the customer, the apparatus 200, for example, via the reserved stock classifier circuitry 212, may record the actual number executed by the client in the log or report.

As described above, example embodiments provide methods and apparatuses that enable improved and enhanced securities lending. Example embodiments thus provide tools that overcome the problems faced determining an accurate number of stocks to be allocated based on various factors. Finally, by automating functionality that has historically required human analysis, the speed and consistency of the predictions performed by example embodiments unlocks many potential new functions that have historically not been available, such as the ability to predict the number of stocks to reserve for a large number of transactions per day and at a quick pace.

FIG. 7 illustrate a flowchart describing sets of operations performed by apparatuses, methods, and computer program products according to various example embodiments. It will be understood that each block of the flowcharts, and combinations of blocks in the flowcharts, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for enhanced securities lending, the method comprising:
receiving, by an input-output circuitry, a request from a first user for a first number of stocks in a security to be executed in a first trade;
determining, by a client locate circuitry, a quote for a second number of stocks in the security, wherein the second number of stocks is less than or equal to the first number of stocks;
predicting, by a reserved stock classifier circuitry and based on (1) a history of engagement of the first user, (2) the first number of stocks, and (3) the second number of stocks, and using a combination of a first classifier from a classical computer and a second classifier from a quantum computer, a third number of stocks in the security to be reserved, the third number of stocks being less than or equal to the second number of stocks;
reserving, by the reserved stock classifier circuitry, the third number of stocks for execution by the first user;
decrementing, by the reserved stock classifier circuitry, a total number of stocks in the security by the third number of stocks;
causing, by the input-output circuitry, execution of a second trade involving a second user and an unreserved number of stocks, wherein the unreserved number of stocks is less than or equal to the total number of stocks minus the third number of stocks;
receiving, by the input-output circuitry, a confirmation from the first user for a fourth number of stocks in the security, wherein the fourth number of stocks is less than or equal to the first number of stocks; and
causing, by the input-output circuitry, execution of the first trade involving the first user and the fourth number of stocks.

2. The method of claim 1, wherein predicting the third number of stocks utilizes a quantum reinforcement learning technique.

3. The method of claim 1, wherein predicting the third number of stocks utilizes a quantum annealer or quantum computer of the reserved stock classifier circuitry.

4. The method of claim 3, wherein predicting the third number of stocks further utilizes a classical computing device.

5. The method of claim 1, further comprising managing, by the reserved stock classifier circuitry, a log documenting how the client locate circuitry determined the second number of stocks and how the reserved stock classifier circuitry predicted the third number of stocks.

6. The method of claim 5, wherein the reserved stock classifier circuitry predicts the third number of stocks in the security using a combination of the first classifier from the classical computer and the second classifier from the quantum computer.

7. The method of claim 5, wherein the log documenting how the reserved stock classifier circuitry predicted the third number of stocks is based on one or more of current regulatory requirements or an internal audit or governance.

8. The method of claim 1, wherein the history of engagement of the first user includes an actual amount of stock executed by the first user.

9. The method of claim 1, wherein predicting the third number of stocks is performed via a reserve stock classifier of a reserve stock classifier circuitry, and further comprising:
receiving, by the reserved stock classifier circuitry, the fourth number of stocks actually executed by the first user, wherein the first number of stocks, the second number of stocks, the third number of stocks, and the fourth number of stocks are utilized to re-train a reserved stock classifier of the reserved stock classifier circuitry.

10. The method of claim 1, wherein the reserved stock classifier circuitry predicts the third number of stocks using a reserved stock classifier of the reserved stock classifier circuitry.

11. The method of claim 10, wherein the reserved stock classifier comprises a machine learning model.

12. The method of claim 11, wherein the reserved stock classifier is generated by at least a quantum computer.

13. The method of claim 12, wherein the reserved stock classifier is further generated by, in addition to the quantum computer, a classical computer.

14. An apparatus for enhanced security lending, the apparatus comprising:
input-output circuitry configured to receive a request from a first user for a first number of stocks in a particular-security to be executed in a first trade;
client locate circuitry configured to:
determine a quote for a second number of stocks in the security, wherein the second number of stocks is less than or equal to the first number of stocks; and
reserved stock classifier circuitry configured to:
predict, based on (1) a history of engagement of the first user, (2) the first number of stocks, and (3) the second number of stocks, and using a combination of a first classifier from a classical computer and a second classifier from a quantum computer, a third number of stocks in the security to be reserved, the third number of stocks being less than or equal to the second number of stocks,
reserve the third number of stocks for execution by the first user, and
decrement a total number of stocks in the security by the third number of stocks,
wherein the input-output circuitry is further configured to:
cause execution of a second trade involving a second user and an unreserved number of stocks, wherein the unreserved number of stocks is less than or equal to the total number of stocks minus the third number of stocks;
receive a confirmation from the first user for a fourth number of stocks in the security, wherein the fourth number of stocks is less than or equal to the first number of stocks, and
cause execution of the first trade involving the first user and the fourth number of stocks.

15. The apparatus of claim 14, wherein the client locate circuitry is further configured to generate a report based on the determined quote for the second number of stocks in the security.

16. The apparatus of claim 15, wherein the report includes explanation on how the second number is determined.

17. The apparatus of claim 14, wherein the reserved stock classifier circuitry is further configured to generate a report based on the third number of stocks in the security.

18. The apparatus of claim 17, wherein the report includes explanation on how the third number is predicted.

19. The apparatus of claim 14, wherein the third number of stocks are predicted using a quantum computer.

20. The apparatus of claim 19, wherein the third number of stocks are predicted using a classical computer.

21. The apparatus of claim 14, wherein the third number of stocks are predicted using one or more of a machine learning model or statistical model.

22. The apparatus of claim 14, wherein the client locate circuitry is further configured to transmit the quote for the second number of stocks in the security available for lending to the first user.

23. A computer program product for enhanced security lending, the computer program product comprising at least one non-transitory computer-readable storage medium storing software instructions that, when executed, cause an apparatus to:
receive a request from a first user for a first number of stocks in a security to be executed in a first trade;
determine a quote for a second number of stocks in the security, wherein the second number of stocks is less than or equal to the first number of stocks;
predict, based on (1) a history of engagement of the first user, (2) the first number of stocks, and (3) the second number of stocks, and using a combination of a first classifier from a classical computer and a second classifier from a quantum computer, a third number of stocks in the security to be reserved, the third number of stocks being less than or equal to the second number of stocks;
reserve the third number of stocks for execution by the first user;
decrement a total number of stocks in the security by the third number of stocks,
cause execution of a second trade involving a second user and an unreserved number of stocks, wherein the unreserved number of stocks is less than or equal to the total number of stocks minus the third number of stocks;
receive a confirmation from the first user for a fourth number of stocks in the security, wherein the fourth number of stocks is less than or equal to the first number of stocks; and
cause execution of the first trade involving the first user and the fourth number of stocks.

24. The computer program product of claim 23, wherein subsequent to a determined quote for the second number of stocks in the security, executed instructions cause the apparatus to generate a report based on the determined quote for the second number of stocks in the security.
